(19) United States
(12) Patent Application Publication
(10) Pub. No.: US 2024/0232387 A1
(43) Pub. Date: Jul. 11, 2024

(54) INTERCEPTING AND SECURING BACKUP TRAFFIC

(71) Applicant: Rubrik, Inc., Palo Alto, CA (US)

(72) Inventors: Deepti Kochar, San Mateo, CA (US); Prabhu Mohan, Morganville, NJ (US); Prasenjit Sarkar, Los Gatos, CA (US); Yanzhe Wang, Santa Clara, CA (US)

(21) Appl. No.: 18/095,374

(22) Filed: Jan. 10, 2023

(51) Int. Cl. G06F 21/60; G06F 11/14

(52) U.S. Cl. CPC G06F 21/602; G06F 11/1448; G06F 2201/80

(57) ABSTRACT

Methods, systems, and devices for data management are described. A data management system may request a backup from a host environment, and the host environment may preload, in response to receiving the request, a library configured to intercept backup communication traffic at the host environment. The host environment may execute the backup procedure for backing up the host data store, and communicate, using the preloaded library, backup data resulting from the executed backup procedure between the host environment and the backup system. The backup data may be transmitted using a cryptographic security protocol that encrypts the backup data.

### FIELD OF TECHNOLOGY

The present disclosure relates generally to data management, including techniques for intercepting and securing backup traffic.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports intercepting and securing backup traffic in accordance with aspects of the present disclosure.

FIG. 2 illustrates an example of a computing environment that supports intercepting and securing backup traffic in accordance with aspects of the present disclosure.

FIG. 3 illustrates an example of a process flow that supports intercepting and securing backup traffic in accordance with aspects of the present disclosure.

FIG. 4 illustrates a block diagram of an apparatus that supports intercepting and securing backup traffic in accordance with aspects of the present disclosure.

FIG. 5 illustrates a block diagram of a backup manager that supports intercepting and securing backup traffic in accordance with aspects of the present disclosure.

FIG. 6 illustrates a diagram of a system including a device that supports intercepting and securing backup traffic in accordance with aspects of the present disclosure.

FIGS. 7 through 10 illustrate flowcharts showing methods that support intercepting and securing backup traffic in accordance with aspects of the present disclosure.

### DETAILED DESCRIPTION

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. The DMS may employ data snapshots to support data management and backup. For example, the DMS may cause generation of a snapshot of a host environment, and the snapshot may be stored or managed by the DMS. Subsequently, the snapshot may be used to restore the host environment.

Various types of protocols, such as network file system (NFS), may be used to backup files over a network. However, such protocols may rely on insecure techniques, such as user datagram protocol (UDP) and transmission control protocol (TCP). As such, the backup data transfers (e.g., to the DMS) may be insecure as communications may not be encrypted and hosts and users are not easily authenticated. Further, these protocols may be stateful, which may result in difficult backup failover procedures due to the systems having to maintain a current state associated with a backup procedure. Finally, these protocols may not support backup visibility on the host and may result in increased backup times due to backing up of empty blocks.

Techniques described herein support preloading a library on the host in response to a backup request. The preloaded library is configured to intercept backup traffic, which may support using encrypted communications, backup visibility on the host, and more efficient backup. After receiving a backup request, the host is configured to preload the library before executing the backup procedure. The executed library may intercept backup I/O traffic and forward the traffic to a DMS in a secure manner, such as by using a transport layer security (TLS) protocol. Further, these techniques may support database catalog integration, reduction in size of backup data, use of floating internet protocol (IP) addresses, and parallelized backup procedures. As such, the techniques described herein support secure, efficient, and user friendly backup procedures. These and other techniques are described in further detail with respect to the figures.

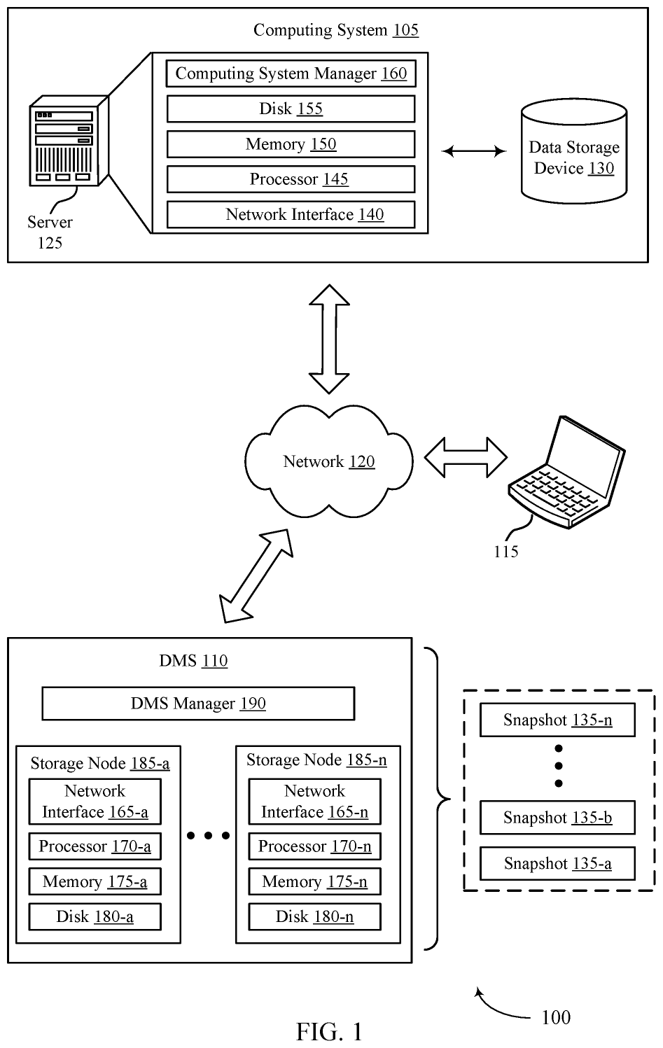

FIG. 1 illustrates an example of a computing environment 100 that supports intercepting and securing backup traffic in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta-of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

As described herein the DMS 110 may function as a backup system for a host data store of the host environment, such as the data storage device 130 of computing system 105. In some cases, the computing system 105 (e.g., the server 125) may execute a backup agent or backup connector to allow the DMS 110 to retrieve snapshots or backups of the data storage device 130. In some cases, the DMS 110 may use a protocol such as network file system (NFS) to backup files from the computing system 105 over the network 120. However, in some examples, such protocols may rely on insecure techniques such as UDP and TCP, which may result in un-encrypted transactions and authentication issues (e.g., users are not easily authenticated). Further, protocols such as NFS may cause “hanging guests” if the server fails, which may result in a filesystem remaining mounted. Additionally, these techniques may result in locking and firewall issues, access-control and user identifier remapping issues, and these issues may be amplified when a single server is supporting multiple clients. Additionally, failover and high availability may be difficult because these protocols may require careful state management.

Techniques described herein address the forging by configuring the host environment (e.g., the computing system 105) to preload a library, after receiving a backup request (e.g., from the DMS 110), that is configured to intercept I/O operations of a backup procedure and communicate backup data to the backup system. Because the I/O operations are intercepted and backup data is communicated using the library, the backup data that is communicated to the backup system (e.g., the DMS 110) may be encrypted or communicated according to cryptographic security protocols, such as TLS. Further, because the backup data is intercepted by the preloaded library, database catalogue integration of the backups may be supported at the host, the size of the backup data may be reduced, the use of floating IPs may be supported, and backups and restores may be parallelized.

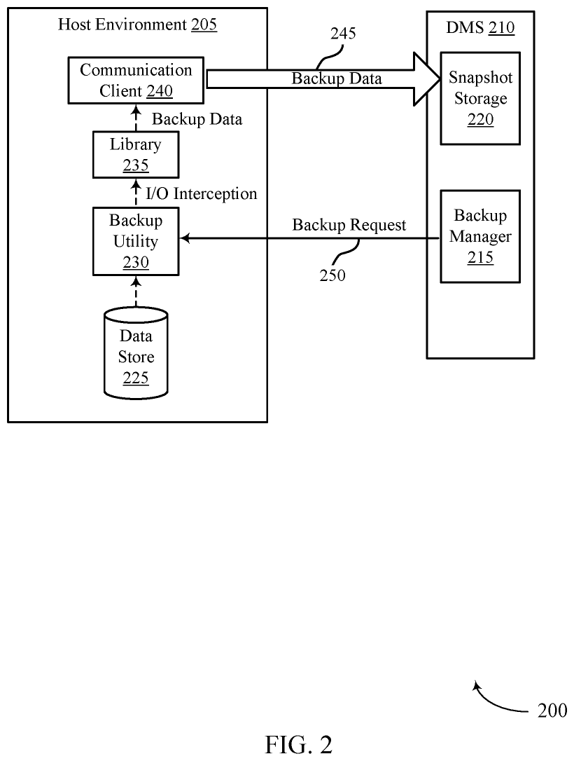

FIG. 2 illustrates an example of a computing environment 200 that supports intercepting and securing backup traffic in accordance with aspects of the present disclosure. The computing environment 200 includes a host environment 205 and a DMS 210. The host environment 205 may be an example of a computing system 105 of FIG. 1, and the DMS 210 may be an example of a DMS 110 of FIG. 1. The host environment 205 may be an example of a host computing environment that supports an organization in data management, application execution, etc. For example, the host environment 205 may execute a set of virtual machines that support various applications, such as a web application, a database server, and/or an application server. The host environment 205 may also support access to a data store 225 that may store, manage, and provide access to organization data. The DMS 210 may be used to support data management, backup, retention, and recovery procedures for one or more host computing environments, such as the host environment 205, as described herein.

The DMS 210 may include a backup manager 215 (e.g., a DMS manager 190 of FIG. 1) that is configured to manage and activate backup procedures for various hosts, such as host environment 205. Thus, when a backup is scheduled or after activation by user, the backup manager 215 may transmit a backup request 250 to a backup utility 230 of the host environment 205. Transmission of the request may include composition of a script of the backup utility 230 and copying the script to the host environment 205 for execution. The backup utility 230 may include or represent aspects of a backup agent. In some examples, the backup utility 230 is a recovery manager configured for the database operating system for the data store 225. The backup utility 230 may execute a backup script such as to read data from the data store 225 and communicate the data to the DMS 210 for snapshotting and/or backup storage. In some systems, the backup utility is configured to communicate backup data to the DMS 210 according to a protocol such as NFS. However, as described herein, the NFS path may not be secure and may cause other issues.

Instead, as described herein, after receiving the backup request 250, the host environment 205 preloads a library 235 that is configured to intercept I/O operations by the backup utility 230 in order to support secure backup data communication as well as other features that are described in further detail herein. To intercept the I/O operations by the backup utility 230, the operating system of the host environment 205 preload the library 235. For example, the backup utility 230 may execute a script (e.g., a backup script) received from the DMS 210 using the preload facility that loads the file system redirector (e.g., the library 235). In some examples, to cause the operating system to preload the library 235, a parameter (e.g., LD_PRELOAD in case of a Linux operating system) of the operating system may be set to a path for the library 235, and, as a result, the file (e.g., the library 235) is loaded before other libraries. As such, the library 235 may process I/O operations by the backup utility 230 before the data is communicated to other libraries. Using the LD_PRELOAD parameter is a technique that influences the linkage of shared libraries and the resolution of symbols (functions) at runtime. The LD_PRELOAD technique is useful in the program execution preparation phase. A Linux system (e.g., as the operating system of the host environment 205) programs ld.so and ld-linux.so (dynamic linker/loader) to use LD_PRELOAD to load specified shared libraries. In particular, before any other library, the dynamic loader may first load shared libraries that are in LD_PRELOAD. Therefore, if the library 235 is specified in LD_PRELOAD, then the backup traffic may be intercepted and securely sent to the DMS 210. Other operating systems, different from Linux, may support preloading of libraries (e.g., library 235) to perform the techniques described herein, and as such, the I/O interception techniques described herein are applicable to other operating systems.

The library 235 may be configured to (e.g., include functions that are configured to) intercept the I/O operations by the backup utility 230 and identify backup data. Thus, when the backup utility 230 starts execution of the backup procedure (after the library 235 is preloaded), the library 235 intercepts the I/O operations of the backup procedure to identify the backup data. The backup data may be communicated to a communication client 240 of the host environment 205 for communication to the DMS 210. In some examples, the library 235 is configured to identify whether the identified I/O operations correspond to unused data blocks of the host data store 225. That is, the library 235 identifies when the backup utility 230 is backing up an empty block of the data store 225. Thus, instead of communicating empty blocks to the DMS 210, the empty blocks are not backed up, which may result in reduced size of the backup and improved backup efficiency.

The host environment 205 may include a file system redirector that loads the library 235 that intercepts file system library calls by the backup utility 230, processes the calls, and forward some of the calls to the communication client 240 (in a backup agent), which may be executing on the localhost. The file system redirector and the backup agent that includes the communication client 240 may communicate using Unix domain sockets with the socket file present in a socket path by default. The file system redirector may not directly communicate with the DMS 210 due to security conflicts in the backup utility 230. It should be understood that the file system redirector and the backup agent that includes the communication client 240 may communicate using other types inter-process communication sockets or endpoints other than Unix domains sockets.

The communication client 240 receives the backup data routed by the library 235 and communicates the backup data to the DMS 210. In some examples, the communication client is an example of a client of an inter-node communication protocol (e.g., Apache Thrift or Google Remote Procedure Call (GRPC)) that supports secure communications, such as TLS. For example, Apache Thrift may be used across DMS (e.g., DMS 210), and the protocol may use a TSSLTransportFactory to obtain a secure socket and to perform certificate management that is provided by DMS infrastructure. Thus, the communication client 240 may communicate the backup data via a secure/encrypted tunnel 245 (e.g., via a cryptographic security protocol such as TLS) to the DMS 210. In some examples, the backup data is communicated to a server of the DMS 210 using the inter-node communication protocol. A service executing on the DMS 210 may handle requests from the communication client 240 and forward the requests to a file system (e.g., snapshot storage 220). Responses from the file system may be marshalled and sent back to the communication client 240.

As described herein, some protocols, such as NFS, may be stateful protocols such as to provide some guarantees when data is shared by multiple hosts or processors. To provide these guarantees, NFS (and similar protocols) may use locks and maintain state. As such, when a system fails, the state is transferred to a new host device. Transfer of state may introduce computing complexities and resource overhead. However, these guarantees, locks, and state, may not be necessary for backup data communication, as multiple processes and hosts may not be accessing the data because the data is backup data. Using the techniques described herein, by intercepting the I/O operations of the backup utility 230 and communicating the data via the communication client 240, the data is communicated using a stateless protocol (e.g., a handshake between the DMS 210 and the host environment 205 is stateless). As such, the communications are more dynamic and flexible. Further, if the DMS 210 fails during a backup procedure, the backup procedure may be easily transferred to another storage node (e.g., snapshot storage 220) because there may be no state transfer.

Further, using the preloading and I/O interception techniques described herein, the computing environment 200 supports database catalog integration, meaning that the backups may be visible from the host environment 205. Some database backup methods use incremental merge, and this technique may not populate the database catalog with backup information. More particularly, incremental merge may involve a single copy of the database at a single point in time and then subsequent merging of incremental changes to the database to that copy. As such, database administrators may not be able to check the catalog for backups. The technique described herein, by controlling the transport protocol between host environment 205 and the DMS 210 using the interception techniques, allows database catalog integration to be implemented. As such, during or after execution of the backup procedure, metadata associated with the backup may be stored in the host data store 225 of the host environment 205. Thus, the metadata and backup may be directly accessible from the host environment 205.

The techniques described herein also support the use of floating IP addresses during upgrades or rolling upgrades at the DMS 210. Because the I/O interception techniques described herein support an inter-node communication protocol, such as Apache Thrift, floating IPs may be applied to nodes or clusters at the DMS 210. The floating IPs of anode being upgraded may be distributed other nodes in the cluster. After the upgrade is complete, an API call may be made to the current IP owner to relinquish the IPs and then to the new owners so that the new owners are able to claim ownership of the IPs. Further, the I/O interception techniques may support parallelization of backups and restores across multiple nodes of the DMS 210. More particularly, the use of I/O interception may support the DMS 210 parallelizing backups and restores to and from the DMS nodes, which may result in improved performance.

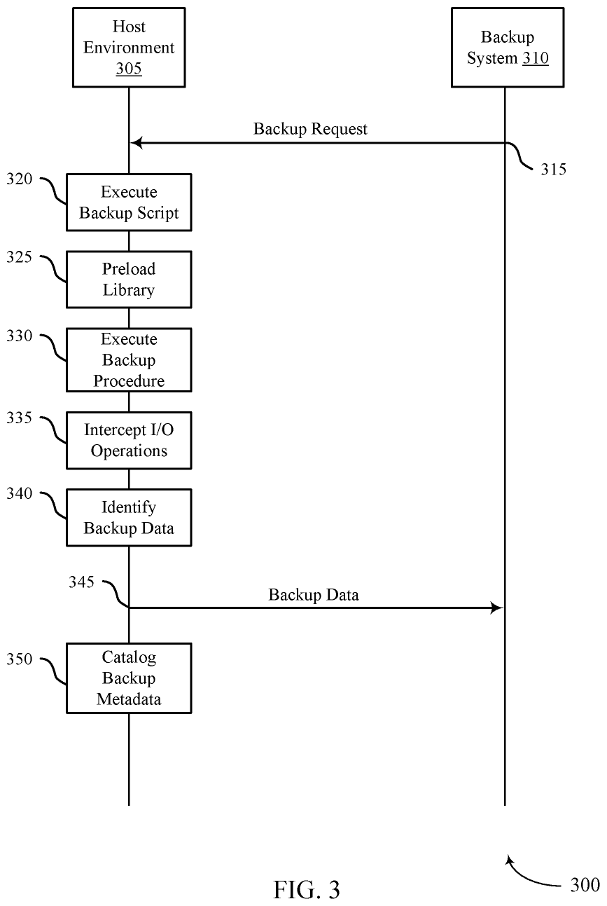

FIG. 3 illustrates an example of a process flow 300 that supports intercepting and securing backup traffic in accordance with aspects of the present disclosure. The process flow 300 includes a host environment 305 and a backup system 310, which may be examples of the corresponding devices as described with respect to FIGS. 1 and 2. For example, the backup system 310 may be an example of a DMS as described herein. In the following description of the process flow 300, the operations between the host environment 305 and the backup system 310 may be transmitted in a different order than the example order shown, or the operations performed may be performed in different orders or at different times. Some operations may also be omitted from the process flow 300, and other operations may be added to the process flow 300.

At 315, the backup system 310 may transmit, and the host environment may receive, a request to execute a backup procedure for backing up a host data store of the host environment.

At 320, the host environment 305 may execute, in response to receiving the request, a backup script using a preload facility of the host environment that preloads the library configured to intercept the backup communication traffic. The library may be configured at, stored, or transmitted to a location on the host environment 305. At 325, the host environment 305 may preload in response to receiving the request, the library configured to intercept backup communication traffic at the host environment. The library may be preloaded based on the library be configured at an operating system (e.g., LD_PRELOAD) of the host environment 305.

At 330, the host environment 305 may execute the backup procedure. Execution of the backup procedure may include execution of I/O operations by a backup utility. For example, the backup utility may read data from the host data store of the host environment 305.

At 335, the host environment 305 may intercept, using the preloaded library (at runtime), input/output operations by a database backup utility of the host environment.

At 340, the host environment 305 may identify, using the preloaded library, input/output operations by a database backup utility of the host environment 305. The host environment 305 may also identify the backup data and unused data blocks of the host data store. In some examples, the host environment 305 may refrain from backing up (e.g., communicating) the unused data blocks.

At 345, the host environment 305 may communicate, using the preloaded library, backup data resulting from the executed backup procedure between the host environment 305 and the backup system 310. Communication of the backup data may include transmitting, using a router service of the host environment that receives the backup data from a file system facility that preloads the library, the backup data to the backup system using a cryptographic security protocol that encrypts the backup data. The cryptographic security protocol may be TLS or another secure communication protocol.

At 350, the host environment 305 may catalog, based at least in part on using the preloaded library, metadata associated with the backup procedure in the host data store of the host environment. As such, the backup may be available at the host environment 305.

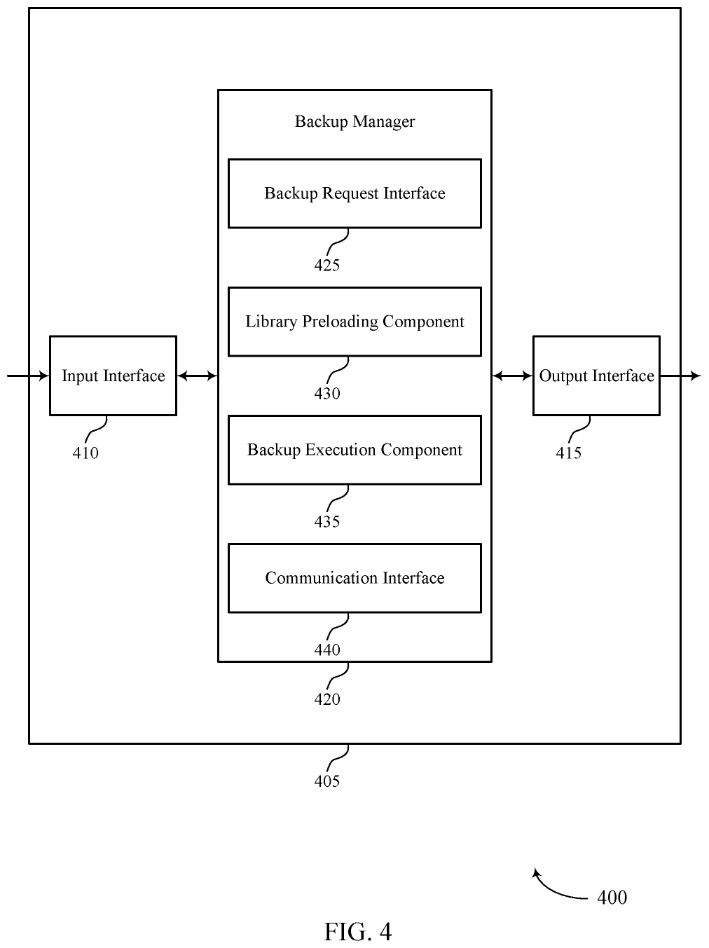

FIG. 4 illustrates a block diagram 400 of a system 405 that supports intercepting and securing backup traffic in accordance with aspects of the present disclosure. In some examples, the system 405 may be an example of aspects of one or more components described with reference to FIG. 1, such as a DMS 110. The system 405 may include an input interface 410, an output interface 415, and a backup manager 420. The system 405 may also include one or more processors. Each of these components may be in communication with one another (e.g., via one or more buses, communications links, communications interfaces, or any combination thereof).

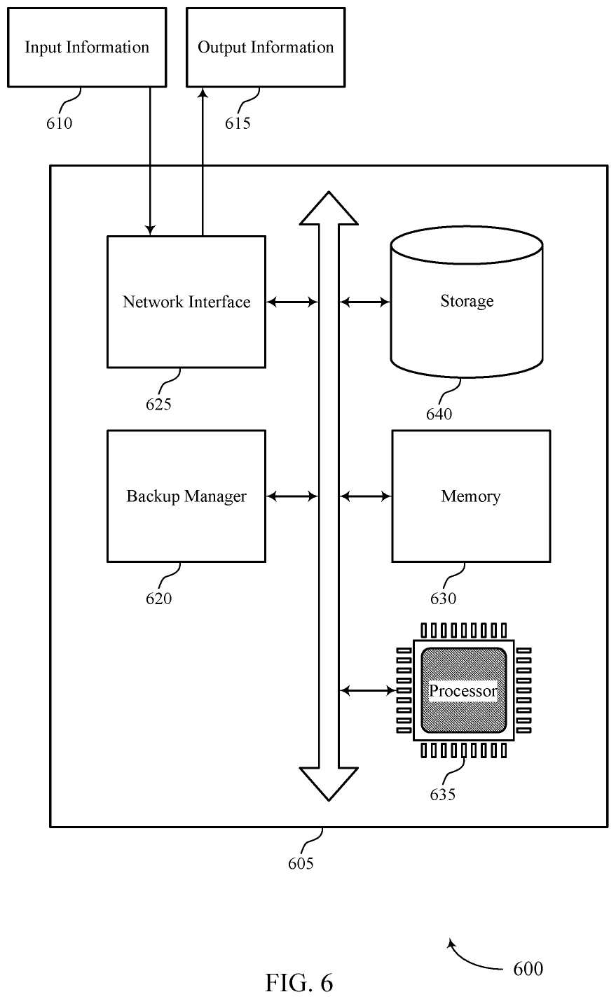

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the backup manager 420 to support intercepting and securing backup traffic. In some cases, the input interface 410 may be a component of a network interface 625 as described with reference to FIG. 6.

The output interface 415 may manage output signaling for the system 405. For example, the output interface 415 may receive signaling from other components of the system 405, such as the backup manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the backup manager 420 may include a backup request interface 425, a library preloading component 430, a backup execution component 435, a communication interface 440, or any combination thereof. In some examples, the backup manager 420, or various components thereof, may be configured to perform various operations (e.g., receiving, monitoring, transmitting) using or otherwise in cooperation with the input interface 410, the output interface 415, or both. For example, the backup manager 420 may receive information from the input interface 410, send information to the output interface 415, or be integrated in combination with the input interface 410, the output interface 415, or both to receive information, transmit information, or perform various other operations as described herein.

The backup manager 420 may support data management in accordance with examples as disclosed herein. The backup request interface 425 may be configured as or otherwise support a means for receiving, at a host environment from a backup system, a request to execute a backup procedure for backing up a host data store of the host environment. The library preloading component 430 may be configured as or otherwise support a means for preloading, in response to receiving the request, a library configured to intercept backup communication traffic at the host environment. The backup execution component 435 may be configured as or otherwise support a means for executing, in response to receiving the request, the backup procedure for backing up the host data store. The communication interface 440 may be configured as or otherwise support a means for communicating, using the preloaded library, backup data resulting from the executed backup procedure between the host environment and the backup system.

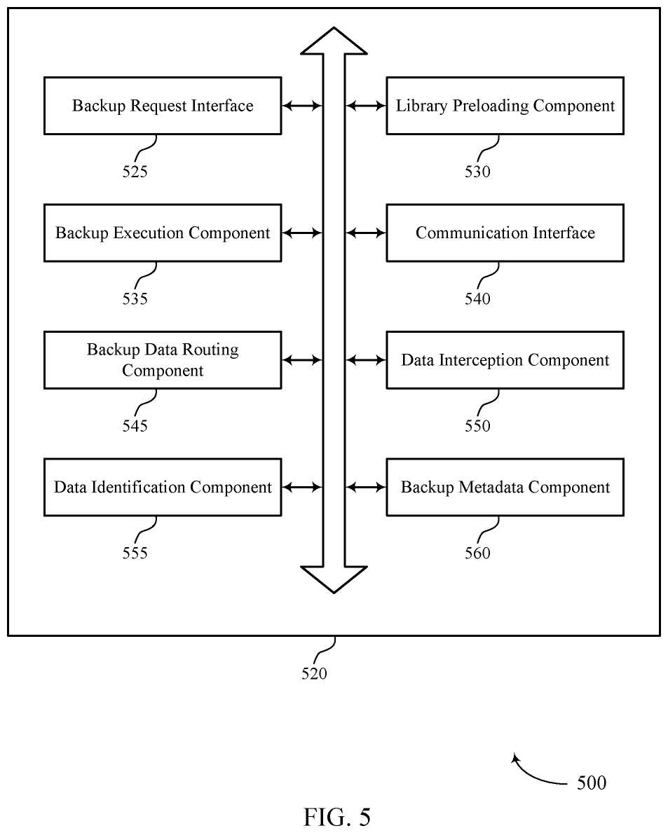

FIG. 5 illustrates a block diagram 500 of a backup manager 520 that supports intercepting and securing backup traffic in accordance with aspects of the present disclosure. The backup manager 520 may be an example of aspects of a backup manager or a backup manager 420, or both, as described herein. The backup manager 520, or various components thereof, may be an example of means for performing various aspects of intercepting and securing backup traffic as described herein. For example, the backup manager 520 may include a backup request interface 525, a library preloading component 530, a backup execution component 535, a communication interface 540, a backup data routing component 545, a data interception component 550, a data identification component 555, a backup metadata component 560, or any combination thereof. Each of these components may communicate, directly or indirectly, with one another (e.g., via one or more buses, communications links, communications interfaces, or any combination thereof).

The backup manager 520 may support data management in accordance with examples as disclosed herein. The backup request interface 525 may be configured as or otherwise support a means for receiving, at a host environment from a backup system, a request to execute a backup procedure for backing up a host data store of the host environment. The library preloading component 530 may be configured as or otherwise support a means for preloading, in response to receiving the request, a library configured to intercept backup communication traffic at the host environment. The backup execution component 535 may be configured as or otherwise support a means for executing, in response to receiving the request, the backup procedure for backing up the host data store. The communication interface 540 may be configured as or otherwise support a means for communicating, using the preloaded library, backup data resulting from the executed backup procedure between the host environment and the backup system.

In some examples, to support communicating the backup data, the backup data routing component 545 may be configured as or otherwise support a means for transmitting, using a router service of the host environment that receives the backup data from a file system facility that preloads the library, the backup data to the backup system using a cryptographic security protocol that encrypts the backup data.

In some examples, the cryptographic security protocol is transport layer security.

In some examples, to support preloading the library, the backup execution component 535 may be configured as or otherwise support a means for executing, in response to receiving the request, a backup script using a preload facility of the host environment that preloads the library configured to intercept the backup communication traffic.

In some examples, intercepting, using the preloaded library, input/output operations by a database backup utility of the host environment. In some examples, identifying the backup data from the intercepted input/output operations, where the identified backup data is communicated to the backup system.

In some examples, the backup metadata component 560 may be configured as or otherwise support a means for cataloging, based on using the preloaded library, metadata associated with the backup procedure in the host data store of the host environment.

In some examples, the data identification component 555 may be configured as or otherwise support a means for identifying, based on using the preloaded library, unused data blocks of the host data store; and. In some examples, the data identification component 555 may be configured as or otherwise support a means for determining to refrain from backing up the unused data blocks.

FIG. 6 illustrates a block diagram 600 of a system 605 that supports intercepting and securing backup traffic in accordance with aspects of the present disclosure. The system 605 may be an example of or include the components of a system 405 as described herein. The system 605 may include components for data management, including components such as a backup manager 620, an input information 610, an output information 615, a network interface 625, a memory 630, a processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting intercepting and securing backup traffic). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

The backup manager 620 may support data management in accordance with examples as disclosed herein. For example, the backup manager 620 may be configured as or otherwise support a means for receiving, at a host environment from a backup system, a request to execute a backup procedure for backing up a host data store of the host environment. The backup manager 620 may be configured as or otherwise support a means for preloading, in response to receiving the request, a library configured to intercept backup communication traffic at the host environment. The backup manager 620 may be configured as or otherwise support a means for executing, in response to receiving the request, the backup procedure for backing up the host data store. The backup manager 620 may be configured as or otherwise support a means for communicating, using the preloaded library, backup data resulting from the executed backup procedure between the host environment and the backup system.

By including or configuring the backup manager 620 in accordance with examples as described herein, the system 605 may support techniques for intercepting and securing backup traffic, which may provide one or more benefits such as, for example, more secure backup communication, backup access at a host environment (e.g., backup catalog), reduced backup size, and improved backup efficiencies, among other possibilities.

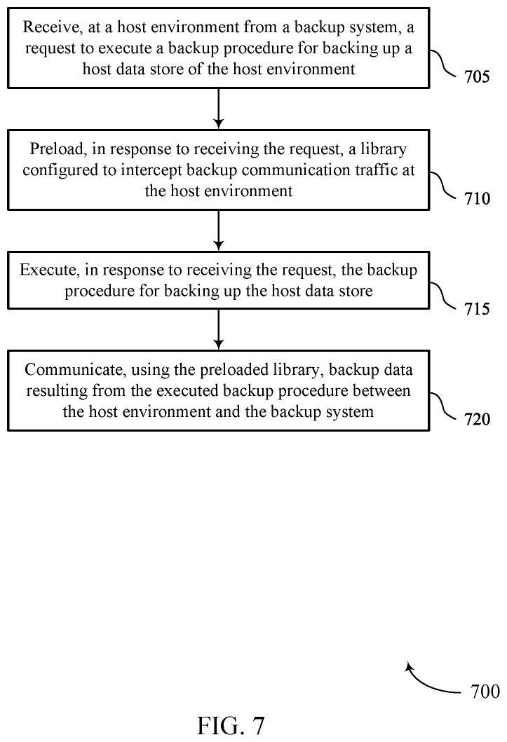

FIG. 7 illustrates a flowchart showing a method 700 that supports intercepting and securing backup traffic in accordance with aspects of the present disclosure. The operations of the method 700 may be implemented by a host environment or its components as described herein. For example, the operations of the method 700 may be performed by a host environment as described with reference to FIGs. FIG. 1 through 6. In some examples, a host environment may execute a set of instructions to control the functional elements of the host environment to perform the described functions. Additionally, or alternatively, the host environment may perform aspects of the described functions using special-purpose hardware.

At 705, the method may include receiving, at a host environment from a backup system, a request to execute a backup procedure for backing up a host data store of the host environment. The operations of 705 may be performed in accordance with examples as disclosed herein. In some examples, aspects of the operations of 705 may be performed by a backup request interface 525 as described with reference to FIG. 5.

At 710, the method may include preloading, in response to receiving the request, a library configured to intercept backup communication traffic at the host environment. The operations of 710 may be performed in accordance with examples as disclosed herein. In some examples, aspects of the operations of 710 may be performed by a library preloading component 530 as described with reference to FIG. 5.

At 715, the method may include executing, in response to receiving the request, the backup procedure for backing up the host data store. The operations of 715 may be performed in accordance with examples as disclosed herein. In some examples, aspects of the operations of 715 may be performed by a backup execution component 535 as described with reference to FIG. 5.

At 720, the method may include communicating, using the preloaded library, backup data resulting from the executed backup procedure between the host environment and the backup system. The operations of 720 may be performed in accordance with examples as disclosed herein. In some examples, aspects of the operations of 720 may be performed by a communication interface 540 as described with reference to FIG. 5.

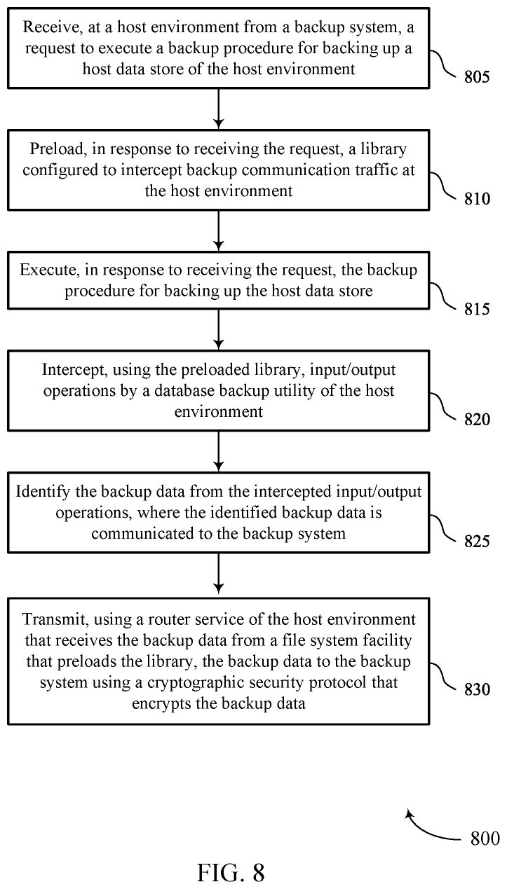

FIG. 8 illustrates a flowchart showing a method 800 that supports intercepting and securing backup traffic in accordance with aspects of the present disclosure. The operations of the method 800 may be implemented by a host environment or its components as described herein. For example, the operations of the method 800 may be performed by a host environment as described with reference to FIGS. 1 through 6. In some examples, a host environment may execute a set of instructions to control the functional elements of the host environment to perform the described functions. Additionally, or alternatively, the host environment may perform aspects of the described functions using special-purpose hardware.

At 805, the method may include receiving, at a host environment from a backup system, a request to execute a backup procedure for backing up a host data store of the host environment. The operations of 805 may be performed in accordance with examples as disclosed herein. In some examples, aspects of the operations of 805 may be performed by a backup request interface 525 as described with reference to FIG. 5.

At 810, the method may include preloading, in response to receiving the request, a library configured to intercept backup communication traffic at the host environment. The operations of 810 may be performed in accordance with examples as disclosed herein. In some examples, aspects of the operations of 810 may be performed by a library preloading component 530 as described with reference to FIG. 5.

At 815, the method may include executing, in response to receiving the request, the backup procedure for backing up the host data store. The operations of 815 may be performed in accordance with examples as disclosed herein. In some examples, aspects of the operations of 815 may be performed by a backup execution component 535 as described with reference to FIG. 5.

At 820, the method may include intercepting, using the preloaded library, input/output operations by a database backup utility of the host environment. The operations of 820 may be performed in accordance with examples as disclosed herein. In some examples, aspects of the operations of 820 may be performed by a data interception component 550 as described with reference to FIG. 5.

At 825, the method may include identifying the backup data from the intercepted input/output operations, where the identified backup data is communicated to the backup system. The operations of 825 may be performed in accordance with examples as disclosed herein. In some examples, aspects of the operations of 825 may be performed by a data identification component 555 as described with reference to FIG. 5.

At 830, the method may include transmitting, using a router service of the host environment that receives the backup data from a file system facility that preloads the library, the backup data to the backup system using a cryptographic security protocol that encrypts the backup data. The operations of 830 may be performed in accordance with examples as disclosed herein. In some examples, aspects of the operations of 830 may be performed by a backup data routing component 545 as described with reference to FIG. 5.

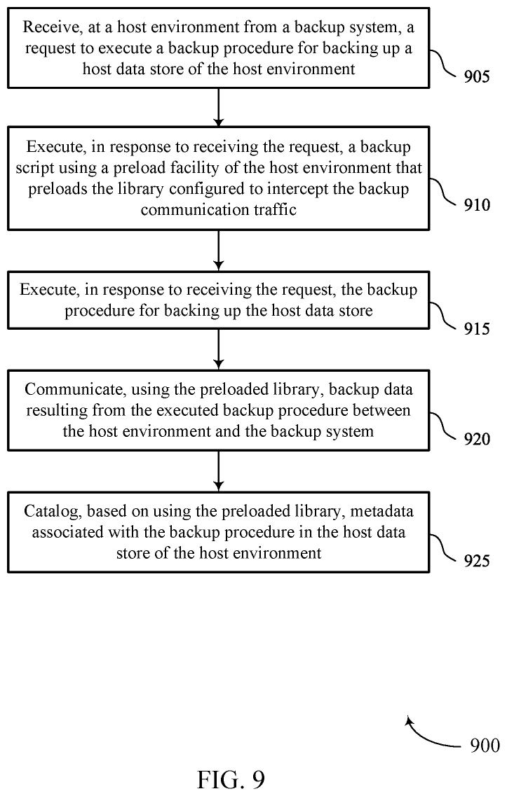

FIG. 9 illustrates a flowchart showing a method 900 that supports intercepting and securing backup traffic in accordance with aspects of the present disclosure. The operations of the method 900 may be implemented by a host environment or its components as described herein. For example, the operations of the method 900 may be performed by a host environment as described with reference to FIGS. 1 through 6. In some examples, a host environment may execute a set of instructions to control the functional elements of the host environment to perform the described functions. Additionally, or alternatively, the host environment may perform aspects of the described functions using special-purpose hardware.

At 905, the method may include receiving, at a host environment from a backup system, a request to execute a backup procedure for backing up a host data store of the host environment. The operations of 905 may be performed in accordance with examples as disclosed herein. In some examples, aspects of the operations of 905 may be performed by a backup request interface 525 as described with reference to FIG. 5.

At 910, the method may include executing, in response to receiving the request, a backup script using a preload facility of the host environment that preloads the library configured to intercept the backup communication traffic. The operations of 910 may be performed in accordance with examples as disclosed herein. In some examples, aspects of the operations of 910 may be performed by a backup execution component 535 as described with reference to FIG. 5.

At 915, the method may include executing, in response to receiving the request, the backup procedure for backing up the host data store. The operations of 915 may be performed in accordance with examples as disclosed herein. In some examples, aspects of the operations of 915 may be performed by a backup execution component 535 as described with reference to FIG. 5.

At 920, the method may include communicating, using the preloaded library, backup data resulting from the executed backup procedure between the host environment and the backup system. The operations of 920 may be performed in accordance with examples as disclosed herein. In some examples, aspects of the operations of 920 may be performed by a communication interface 540 as described with reference to FIG. 5.

At 925, the method may include cataloging, based on using the preloaded library, metadata associated with the backup procedure in the host data store of the host environment. The operations of 925 may be performed in accordance with examples as disclosed herein. In some examples, aspects of the operations of 925 may be performed by a backup metadata component 560 as described with reference to FIG. 5.

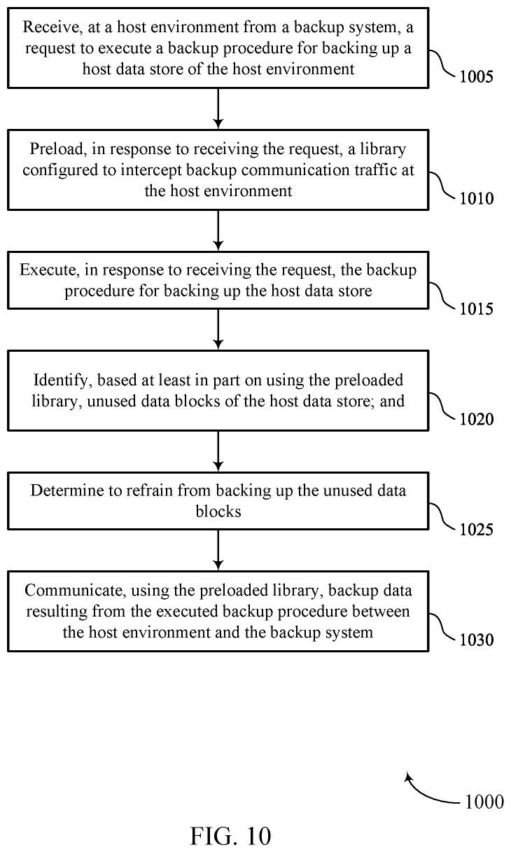

FIG. 10 illustrates a flowchart showing a method 1000 that supports intercepting and securing backup traffic in accordance with aspects of the present disclosure. The operations of the method 1000 may be implemented by a host environment or its components as described herein. For example, the operations of the method 1000 may be performed by a host environment as described with reference to FIGS. 1 through 6. In some examples, a host environment may execute a set of instructions to control the functional elements of the host environment to perform the described functions. Additionally, or alternatively, the host environment may perform aspects of the described functions using special-purpose hardware.

At 1005, the method may include receiving, at a host environment from a backup system, a request to execute a backup procedure for backing up a host data store of the host environment. The operations of 1005 may be performed in accordance with examples as disclosed herein. In some examples, aspects of the operations of 1005 may be performed by a backup request interface 525 as described with reference to FIG. 5.

At 1010, the method may include preloading, in response to receiving the request, a library configured to intercept backup communication traffic at the host environment. The operations of 1010 may be performed in accordance with examples as disclosed herein. In some examples, aspects of the operations of 1010 may be performed by a library preloading component 530 as described with reference to FIG. 5.

At 1015, the method may include executing, in response to receiving the request, the backup procedure for backing up the host data store. The operations of 1015 may be performed in accordance with examples as disclosed herein. In some examples, aspects of the operations of 1015 may be performed by a backup execution component 535 as described with reference to FIG. 5.

At 1020, the method may include identifying, based on using the preloaded library, unused data blocks of the host data store; and. The operations of 1020 may be performed in accordance with examples as disclosed herein. In some examples, aspects of the operations of 1020 may be performed by a data identification component 555 as described with reference to FIG. 5.

At 1025, the method may include determining to refrain from backing up the unused data blocks. The operations of 1025 may be performed in accordance with examples as disclosed herein. In some examples, aspects of the operations of 1025 may be performed by a data identification component 555 as described with reference to FIG. 5.

At 1030, the method may include communicating, using the preloaded library, backup data resulting from the executed backup procedure between the host environment and the backup system. The operations of 1030 may be performed in accordance with examples as disclosed herein. In some examples, aspects of the operations of 1030 may be performed by a communication interface 540 as described with reference to FIG. 5.

A method for data management is described. The method may include receiving, at a host environment from a backup system, a request to execute a backup procedure for backing up a host data store of the host environment, preloading, in response to receiving the request, a library configured to intercept backup communication traffic at the host environment, executing, in response to receiving the request, the backup procedure for backing up the host data store, and communicating, using the preloaded library, backup data resulting from the executed backup procedure between the host environment and the backup system.

An apparatus for data management is described. The apparatus may include a processor, memory coupled with the processor, and instructions stored in the memory. The instructions may be executable by the processor to cause the apparatus to receive, at a host environment from a backup system, a request to execute a backup procedure for backing up a host data store of the host environment, preload, in response to receiving the request, a library configured to intercept backup communication traffic at the host environment, execute, in response to receiving the request, the backup procedure for backing up the host data store, and communicating, using the preloaded library, backup data resulting from the executed backup procedure between the host environment and the backup system.

Another apparatus for data management is described. The apparatus may include means for receiving, at a host environment from a backup system, a request to execute a backup procedure for backing up a host data store of the host environment, means for preloading, in response to receiving the request, a library configured to intercept backup communication traffic at the host environment, means for executing, in response to receiving the request, the backup procedure for backing up the host data store, and means for communicating, using the preloaded library, backup data resulting from the executed backup procedure between the host environment and the backup system.

A non-transitory computer-readable medium storing code for data management is described. The code may include instructions executable by a processor to receive, at a host environment from a backup system, a request to execute a backup procedure for backing up a host data store of the host environment, preload, in response to receiving the request, a library configured to intercept backup communication traffic at the host environment, execute, in response to receiving the request, the backup procedure for backing up the host data store, and communicating, using the preloaded library, backup data resulting from the executed backup procedure between the host environment and the backup system.

In some examples of the method, apparatuses, and non-transitory computer-readable medium described herein, communicating the backup data may include operations, features, means, or instructions for transmitting, using a router service of the host environment that receives the backup data from a file system facility that preloads the library, the backup data to the backup system using a cryptographic security protocol that encrypts the backup data.

In some examples of the method, apparatuses, and non-transitory computer-readable medium described herein, the cryptographic security protocol may be transport layer security.

In some examples of the method, apparatuses, and non-transitory computer-readable medium described herein, preloading the library may include operations, features, means, or instructions for executing, in response to receiving the request, a backup script using a preload facility of the host environment that preloads the library configured to intercept the backup communication traffic.

Some examples of the method, apparatuses, and non-transitory computer-readable medium described herein may further include operations, features, means, or instructions for intercepting, using the preloaded library, input/output operations by a database backup utility of the host environment and identifying the backup data from the intercepted input/output operations, where the identified backup data may be communicated to the backup system.

Some examples of the method, apparatuses, and non-transitory computer-readable medium described herein may further include operations, features, means, or instructions for cataloging, based on using the preloaded library, metadata associated with the backup procedure in the host data store of the host environment.

In some examples of the method, apparatuses, and non-transitory computer-readable medium described herein, identifying, based on using the preloaded library, unused data blocks of the host data store; and determining to refrain from backing up the unused data blocks.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
receiving, at a host environment from a backup system, a request to execute a backup procedure for backing up a host data store of the host environment;
preloading, in response to receiving the request, a library configured to intercept backup communication traffic at the host environment;
executing, in response to receiving the request, the backup procedure for backing up the host data store; and
communicating, using the preloaded library, backup data resulting from the executed backup procedure between the host environment and the backup system.

2. The method of claim 1, wherein communicating the backup data comprises:
transmitting, using a router service of the host environment that receives the backup data from a file system facility that preloads the library, the backup data to the backup system using a cryptographic security protocol that encrypts the backup data.

3. The method of claim 2, wherein the cryptographic security protocol is transport layer security.

4. The method of claim 1, wherein preloading the library comprises:
executing, in response to receiving the request, a backup script using a preload facility of the host environment that preloads the library configured to intercept the backup communication traffic.

5. The method of claim 1, wherein communicating the backup data comprise:
intercepting, using the preloaded library, input/output operations by a database backup utility of the host environment; and
identifying the backup data from the intercepted input/output operations, wherein the identified backup data is communicated to the backup system.

6. The method of claim 1, further comprising:
cataloging, based at least in part on using the preloaded library, metadata associated with the backup procedure in the host data store of the host environment.

7. The method of claim 1, further comprising:
identifying, based at least in part on using the preloaded library, unused data blocks of the host data store; and; and
determining to refrain from backing up the unused data blocks.

8. An apparatus for data management, comprising:
a processor;
memory coupled with the processor; and
instructions stored in the memory and executable by the processor to cause the apparatus to:
receive, at a host environment from a backup system, a request to execute a backup procedure for backing up a host data store of the host environment;
preload, in response to receiving the request, a library configured to intercept backup communication traffic at the host environment;
execute, in response to receiving the request, the backup procedure for backing up the host data store; and
communicate, using the preloaded library, backup data resulting from the executed backup procedure between the host environment and the backup system.

9. The apparatus of claim 8, wherein the instructions to communicate the backup data are executable by the processor to cause the apparatus to:
transmit, using a router service of the host environment that receives the backup data from a file system facility that preloads the library, the backup data to the backup system using a cryptographic security protocol that encrypts the backup data.

10. The apparatus of claim 9, wherein:
the cryptographic security protocol is transport layer security.

11. The apparatus of claim 8, wherein the instructions to preload the library are executable by the processor to cause the apparatus to:
execute, in response to receiving the request, a backup script using a preload facility of the host environment that preloads the library configured to intercept the backup communication traffic.

12. The apparatus of claim 8, wherein:
intercept, using the preloaded library, input/output operations by a database backup utility of the host environment; and
identify the backup data from the intercepted input/output operations, wherein the identified backup data is communicated to the backup system.

13. The apparatus of claim 8, wherein the instructions are further executable by the processor to cause the apparatus to:
catalog, based at least in part on using the preloaded library, metadata associated with the backup procedure in the host data store of the host environment.

14. The apparatus of claim 8, wherein the instructions are further executable by the processor to cause the apparatus to:
identify, based at least in part on using the preloaded library, unused data blocks of the host data store; and; and
determine to refrain from backing up the unused data blocks.

15. A non-transitory computer-readable medium storing code for data management, the code comprising instructions executable by a processor to:
receive, at a host environment from a backup system, a request to execute a backup procedure for backing up a host data store of the host environment;
preload, in response to receiving the request, a library configured to intercept backup communication traffic at the host environment;
execute, in response to receiving the request, the backup procedure for backing up the host data store; and
communicate, using the preloaded library, backup data resulting from the executed backup procedure between the host environment and the backup system.

16. The non-transitory computer-readable medium of claim 15, wherein the instructions to communicate the backup data are executable by the processor to:
transmit, using a router service of the host environment that receives the backup data from a file system facility that preloads the library, the backup data to the backup system using a cryptographic security protocol that encrypts the backup data.

17. The non-transitory computer-readable medium of claim 16, wherein:
the cryptographic security protocol is transport layer security.

18. The non-transitory computer-readable medium of claim 15, wherein the instructions to preload the library are executable by the processor to:
execute, in response to receiving the request, a backup script using a preload facility of the host environment that preloads the library configured to intercept the backup communication traffic.

19. The non-transitory computer-readable medium of claim 15, wherein:
intercept, using the preloaded library, input/output operations by a database backup utility of the host environment; and
identify the backup data from the intercepted input/output operations, wherein the identified backup data is communicated to the backup system.

20. The non-transitory computer-readable medium of claim 15, wherein the instructions are further executable by the processor to:
catalog, based at least in part on using the preloaded library, metadata associated with the backup procedure in the host data store of the host environment.
